(19) United States
(12) Patent Application Publication
(10) Pub. No.: US 2014/0351173 A1
(43) Pub. Date: Nov. 27, 2014

(54) APPARATUS AND METHOD FOR RECEIVING REGISTERED POST

(71) Applicant: ELECTRONICS AND TELECOMMUNICATIONS RESEARCH INSTITUTE, Daejeon (KR)

(72) Inventor: Eun Hye KIM, Seoul (KR)

(73) Assignee: ELECTRONICS AND TELECOMMUNICATIONS RESEARCH INSTITUTE, Daejeon (KR)

(21) Appl. No.: 14/051,534

(22) Filed: Oct. 11, 2013

(30) Foreign Application Priority Data
May 22, 2013 (KR) 10-2013-0057984

(51) Int. Cl. G06Q 50/32; G06Q 10/08

(52) U.S. Cl. CPC G06Q 50/32; G06Q 10/0833
USPC 705/404; 705/402

(57) ABSTRACT

A method for automating issuing and attachment of a label including post ID information when a user intends to apply a registered post providing tracking and tracing information such as a registration or a parcel service by using an unmanned device of itself and an apparatus for receiving a registered post including a post receiving unit receiving reception information for receiving the registered post including a registered or parcel service post, and a reception information managing unit authenticating a user who intends to apply the registered post and verifying the reception information of the registered post to generate label information for issuing the label including the reception information.

### CROSS-REFERENCE TO RELATED APPLICATIONS

This application claims priority to and the benefit of Korean Patent Application No. 10-2013-0057984 filed in the Korean Intellectual Property Office on May 22, 2013, the entire contents of which are incorporated herein by reference.

### TECHNICAL FIELD

The present invention relates to a method of automating issuing and attaching a label including post ID information when a user intends to apply a registered post providing tracking and tracing information such as a registration or a parcel service by using an unmanned device in person.

### BACKGROUND ART

When a user intends to apply a post providing tracking and tracing information such as a general registration, a parcel service, and the like in a postal field in the related art, the user may apply the post through an unmanned device installed at a desk of a post office or in a region heavily populated, but the unmanned device can be used in only a business time at the time of applying the post at the post office desk and a customer waiting time occurs, in particular, when a large quantity of registrations/parcel posts are dispatched, the customer waiting time increases and a business load of a receptionist increases with an increase of a time required to input reception information such as dispatcher and addressee information in order to provide the tracking and tracing information. When a label including post ID information is issued at the time of applying the post through an unmanned desk, it is inconvenient for the user to attach the label to individual posts in person, and the inconvenience and the load are further added in the case of the large quantity of posts (the user should verify and attach label issue information individually).

A barcode printed on the label is used to sort the posts and for a post processing time scanned and stored for each strongpoint is used to provide the tracking and tracing information, but when printing quality of an issued label barcode is degraded due to an uneven surface of the post during receiving, a failure of a printing device, and the like, there exists cumbersome in which ID information and dispatcher/recipient information should be manually input in a joining business performed at sorting and delivery strongpoints, the tracking and tracing information is cut off to degrade service quality, misrecognition of ID information and as a result, a method is required, for reducing an additional business performed on a distribution process and resulting load and administration cost after receiving the post through verifying the barcode printing quality at the time of receiving the post.

Therefore, there are required an apparatus and a method which increase user convenience by automatically issuing and attaching the label at the time of applying a registered post through the unmanned device and reduce unnecessary administration cost by verifying printing quality of the label in a first process step.

### SUMMARY OF THE INVENTION

The present invention has been made in an effort to provide an apparatus and a method that improve reception convenience of a registered post by automating a reception processing process such as measurement of a specification and a weight of a post, granting of a post ID, issuing of a label including ID information, attaching the label to the surface of the post, and the like when a user intends to apply a registered post providing tracking and tracing information such as a registration, a parcel service by using an unmanned device in person.

An exemplary embodiment of the present invention provides an apparatus for receiving a registered post, including: a post receiving unit receiving reception information for receiving the registered post including a registered or parcel service post; and a reception information managing unit authenticating a user who intends to apply the registered post and verifying the reception information of the registered post to generate label information for issuing the label including the reception information.

The post receiving unit may include an administration information displaying unit providing a user interface for receiving the registered post; a post information measuring unit measuring a specification and a weight of the registered post; a charge calculating unit calculating a postal charge through the measured specification or weight; a label issuing unit issuing a label with label information generated by the reception information managing unit; a label attaching unit attaching the issued label to the registered post; and a loading unit loading a received post or an erroneous post depending on recognition of a barcode of the issued label.

The reception information managing unit may include a member information managing unit managing the user information; a information reception managing unit storing reception information of a registered post previously applied by the user; a label information generating unit generating the label information; a postal address managing unit verifying a postal address of the registered post; a charge managing unit managing a calculated charge of the registered post; and a reception managing unit managing the reception information and the label information.

The registered post receiving apparatus may further include a delivery information managing unit managing the reception information and delivery information depending on delivery of the registered post.

The distribution information managing unit may include a distribution reception information managing unit managing the reception information received from the post receiving unit and the reception information managing unit; a sorting information managing unit managing information sorted depending on destination information of the registered post; a delivery information managing unit managing delivery information of the registered object; a metabolic information managing unit managing quantity information of the registered post based on a predetermined reference; and a statistical information managing unit managing statistical information of the registered post.

The reception information managing unit may receive reception information from the user or receives prestored reception information from the distribution information managing unit depending on presence of prestored reception information of the user.

The post receiving unit may further include a label verifying unit verifying recognition of a barcode of the attached label, and the label issuing unit may reissue a label for an erroneous post in which recognition of the barcode of the label is impossible.

The loading unit may include a received post loading unit loading the received post in which recognition of the barcode of the label is possible, and an erroneous post loading unit loading the erroneous post in which the recognition of the barcode of the label is impossible.

The post receiving unit may further include a post discharging unit discharging the registered post when post reception is cancelled or there is no prestored reception information.

Another exemplary embodiment of the present invention provides a method for receiving a registered post, including: authenticating a user who intends to apply the registered post including a registered or parcel service post; receiving reception information for receiving the registered post; and generating label information for issuing a label including the reception information by verifying the reception information of the registered post.

According to exemplary embodiments of the present invention, use convenience is improved by automating issuing and attachment of a label for registration management at the time of applying a registered post through an unmanned device. A user can apply a post without a stand-by time in a desk of a post office, and all processes other than post input, reception information input, and settlement are automated to simplify a reception process of the registered post and increase resulting applying convenience as issuing and attaching a label including individual post ID information is automated.

As the quality of a barcode printed on the issued label is verified at the time of reception before dispatching the post, rapid system maintenance is enabled, additional businesses which may occur in a conclusion business performed in order to provide the tracking and tracing information of the registered post for each post sorting and delivery strongpoint may be removed, and cut off of tracking and tracing information is prevented.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an apparatus for receiving a registered post according to an exemplary embodiment of the present invention.

FIGS. 2 to 4 are block diagrams illustrating a detailed configuration of the apparatus for receiving a registered post according to the exemplary embodiment of the present invention.

FIG. 5 is a flowchart illustrating a method for receiving a registered post according to another exemplary embodiment of the present invention.

FIG. 6 is a flowchart illustrating a method for receiving a registered post by an apparatus for receiving a registered post according to another exemplary embodiment of the present invention.

FIG. 7 is a flowchart illustrating a step of verifying a label barcode of the method for receiving a registered post according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Contents below just exemplify a principle of the invention. Therefore, the principle of the invention can be implemented and various devices included in the concept of and scope of the invention can be invented although not clearly described or illustrated in the specification. All conditional terms and exemplary embodiment described in the specification are clearly intended to assist understanding the concept of the invention in principle and it should be understood that the invention is not limited to particularly described exemplary embodiments and states.

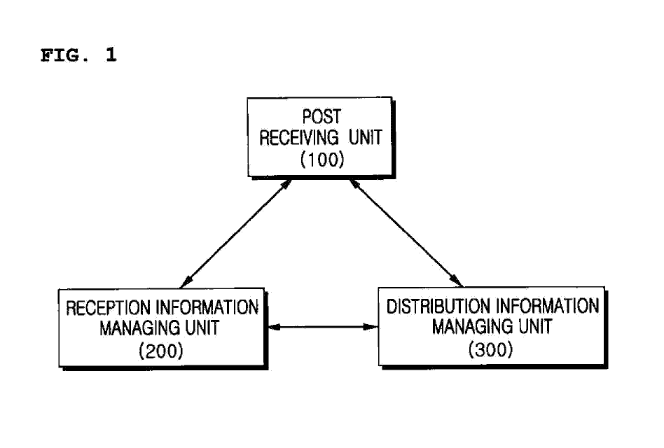

FIG. 1 is a block diagram of a system for automatically receiving a registered post according to an exemplary embodiment of the present invention. A post receiving unit 100, and a reception information managing unit 200 and a distribution information managing unit 300 interwork with each other. In the exemplary embodiment, the post receiving unit 100 represents a device that allows a user to apply a registration or parcel service post providing tracking and tracing information in person, but is not limited to a device that may receive only the registered post providing the tracking and tracing information.

In the exemplary embodiment, the post receiving unit 100 receives reception information for receiving the registered post including the registration or parcel service post.

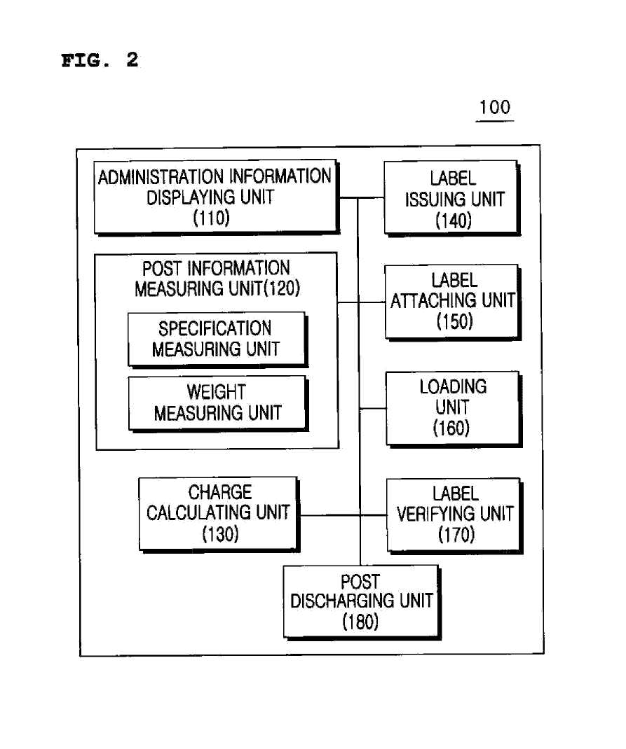

FIG. 2 is a detailed block diagram of the post receiving unit 100 according to the exemplary embodiment of the present invention. As illustrated in FIG. 2, the post receiving unit 100 includes an administration information displaying unit 110, a post information measuring unit 120, a charge calculating unit 130, a label issuing unit 140, a label attaching unit 150, and a loading unit 160.

The administration information displaying unit 110 is a user interface that provides information by a device such as a touch screen so as for the user who applies the registered post to log in, select a service type, and the like.

The post information measuring unit 120 may further include a specification measuring unit 122 and a weight measuring unit 124. In the exemplary embodiment, the specification measuring unit 122 measures a specification of a post when the user inputs the post and the weight measuring unit 124 measures a weight of the input post.

The charge calculating unit 130 judges whether there is a general registration post or a parcel post based on the specification and weight information of the input post, which is measured by the post information measuring unit 120, and calculates a charge depending on specification and weight sections. The charge calculating unit 130 stores charge information settled by the user.

The label issuing unit 140 prints, on a label, information generated by a label information generating unit 230 of the reception information managing unit 200 to be describe below based on address information and recipient information of the post which the user inputs for each input post in person, and association information of a reception post registered in advance in a web page administrated by a postal service provider or a parcel service provider. Information such as a barcode including post ID information, a reception date, a delivery post office, and the like is included in the label and an ID having uniqueness for each post includes information such as an automatic reception system number, a service type, serial number, and the like. As a recipient postal address in the reception information, a verification-completed address is used through a post address managing unit 240.

In this case, in the exemplary embodiment, a method is used, in which when the user inputs the reception information, the label is issued in the order of the input post, when the reception information is associated, the user verifies postal address and recipient information corresponding to the input post for each input post and the label is issued as selected on a screen or letters of the postal address on an envelope/surface of the input post are recognized to match address information corresponding to a recognized address in the associated reception information to issue the label, but the present invention is not particularly limited to any one method.

The label attaching unit 150 determines a label attachment location and automatically attaches the issued label onto the surface of the post. The barcode included in the label attached to the post is recognized by a scanner before being discharged to a post loading unit.

The loading unit 160 loads the received post or an erroneous post depending on recognition of the barcode of the issued label. The post of which the recognition of the barcode is completed is discharged to a received post loading unit, a recognition-impossible post is discharged to an erroneous post loading unit and a receptionist reissues and attaches the label during picking up, so that the label is automatically recognized at each of strongpoints of reception, sorting, and delivery.

Therefore, the post receiving unit 100 according to the exemplary embodiment further includes a label verifying unit 170 verifying whether the barcode of the attached label is recognized, and the label issuing unit 140 reissues the label for the erroneous post of which the barcode of the label cannot be recognized.

Therefore, additional businesses (ID information, Postal address information of a dispatcher/recipient, and the like) may be removed, which may occur in a conclusion business performed to provide registered post tracking and tracing information at post sorting and delivery strongpoints due to a barcode printing failure during reception, and cut-off of the tracking and tracing information may be prevented. It is possible to immediately verify a problem in degradation of printing quality of the label barcode which is issued due to au uneven surface of the input post, a failure of a printing device in the post receiving unit, and as a result, system maintenance may be achieved.

Hereinabove, the post receiving unit 100 stores information of a registered post of which reception is completed, and transmits the stored information to the reception information managing unit 200 or the distribution information managing unit 300.

The post receiving unit 100 according to the exemplary embodiment further includes a post discharging unit 180, and the post discharging unit 180 separately discharges the post when the user cancels post reception by changing his/her mind or the reception information of the input post does not exist while associating the reception information.

The reception information managing unit 200 authenticates a user who intends to apply the registered post and verifies the reception information of the registered post to generate label information for issuing the label including the reception information.

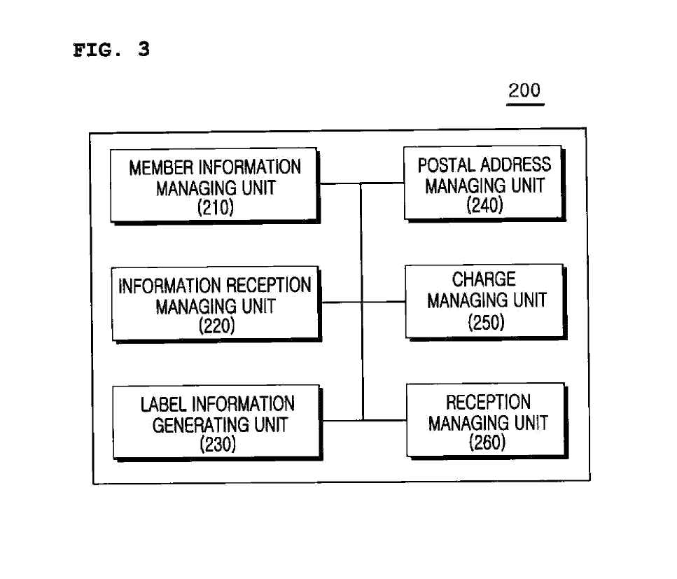

Referring to FIG. 3, the reception information managing unit 200 according to the exemplary embodiment of the present invention includes a member information managing unit 210, a information reception managing unit 220, a label information generating unit 230, a postal address managing unit 240, a charge managing unit 250, and a reception managing unit 260.

The member information managing unit 210 manages information (a user name, a postal address, a number of a mobile terminal used by the user, and the like) registered when the user subscribes in the member through means for collecting information, such as the web page administrated by the postal service provider or parcel service provider. Member information is collected for performance management of the user, providing reception associated information, and the like.

The information reception managing unit 220 stores and manages address information and recipient information of a post which the user applies after selecting a member or selecting a non-member in an automatic registered post receiving system. The user may input a delivery address and a recipient name of the post for each received post in person at the time of applying the post and may call the corresponding postal address and recipient name information by associating the received post information registered in advance, in the web page administrated by the postal service provider or the parcel service provider.

The label information generating unit 230 generates information included in the label attached to the post in order to provide the tracking and tracking service to a post of which reception information is registered. Information such as ID information, a reception date, a delivery post office, and the like is included in the label and an ID having uniqueness for each post includes information such as an automatic reception system number, a service type, a serial number, and the like.

The information reception managing unit 220 receives a recipient postal address in reception information for each user in association with the information managed by the member information managing unit 210 and transfers the recipient postal address to the postal address managing unit 240. The information reception managing unit 220 receives information indicating verification completion or verification failure for information such as si/gun/gu/dong, and the like from the postal address managing unit 240 and when the verification is completed, the information reception managing unit 220 requests transferring the verified recipient postal address to the label information generating unit 230 and generating an ID, and manages the postal address. When the information reception managing unit 220 receives the verification failure, information from the label information generating unit 230, the information reception managing unit 220 provides information indicating that the verification of the recipient postal address registered by the user is failed onto a screen of the system for receiving a registered post to allow the user to recognize the information and input an accurate postal address.

In this case, in the exemplary embodiment of the Present invention, as a method of verifying the postal address, a method is used, which verifies a si/gun/gu/dong address and a postal code corresponding thereto by verifying a postal address of si/gun/gu/dong and comparing the verified postal address with a list which is already stored, but the method is not particularly limited to any one method. Undelivered and returned posts may be reduced through verification of the postal address, and a cost required to process the returned post may also be reduced.

The charge managing unit 250 calculates a charge to be applied to a user who applies the registered post in the automatic reception system, and manages charge calculation information. The charge calculation information includes a user name, a charge which the corresponding user will pay, a charge settlement method, and the like.

The reception managing unit 260 stores and manages the registered post reception information received by the information reception managing unit 220 and the information including the ID an the label generated by the label information generating unit 230 to correspond to each other one to one. That is, the reception managing unit 260 receives and manages reception information input or associated by the user, and reception information such as the ID and a generation date generated by the label information generating unit 230, respectively. The reception managing unit 260 scans a barcode including ID information of a label after automatically outputting and attaching the label in the post receiving unit 100, and receives and manages processing date information and an information inputting means (e.g., automatic, handwriting) which are stored from the post receiving unit 100. ID scan information is managed to correspond to the reception information one to one to verify the printing quality of the barcode included in the label attached to the registered post and prevent an error or a cut-off phenomenon of the tracking and tracing information, which may occur during delivery. To this end, in the exemplary embodiment of the present invention, the corresponding information is managed during a predetermined period and when the corresponding period elapses, the corresponding information is discarded as an example, but is not particularly limited thereto.

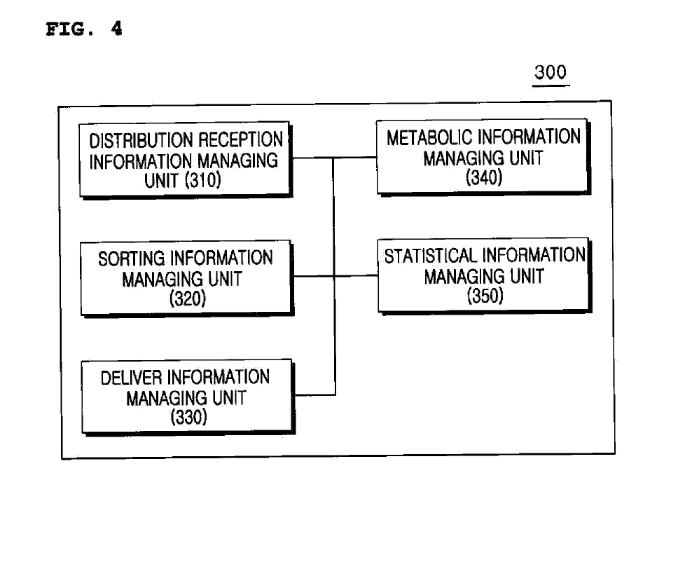

The distribution information managing unit according to the exemplary embodiment manages the reception information and delivery information generated by delivery of the registered post. Referring to FIG. 4, FIG. 4 is a block diagram of the distribution information managing unit 300 according to the exemplary embodiment of the present invention.

As illustrated in FIG. 4, the distribution information managing unit 300 includes a distribution reception information managing unit 310, a sorting information managing unit 320, a delivery information managing unit 330, a metabolic information managing unit 340, and a statistical information managing unit 350.

The distribution reception information managing unit 310 of the distribution information managing unit 300 manages the received registered post information from the post receiving unit 100 and the reception information managing unit 200, and the sorting information managing unit 320 manages information sorted manually or automatically based on destination information of the post for each strongpoint after reception processing.

The delivery information managing unit 330 manages delivery result information of the registered post registered at a strongpoint that is in charge of the delivery. A delivery result may be delivery completion, non-delivery caused due to absence of a recipient, and the like, non-delivery caused due to an unknown address, and the like, and the delivery information managing unit 330 manages information regarding the resulting post returning or storing processing to correspond to a post ID one to one.

The metabolic information managing unit 340 receives the reception information and the delivery result information from the distribution reception information managing unit 310 and the delivery information managing unit 330, respectively to generate and manage quantity information for each delivery result of a received quantity for each user or apparatus for automatically receiving a registered post.

The statistical information managing unit 350 receives metabolic information, reception performance information, and label quality information from the metabolic information managing unit 340 and the reception managing unit 260 of the reception information managing unit 200 to calculate and manage delivery result statistics of the received quantity for each user or apparatus for automatically receiving a registered post, a handwritten input ratio of the registered post ID, and the like. In the exemplary embodiment of the present invention, in the delivery result statistics information of the received quantity, a user who subscribes in a member through the web page administrated by the postal service provider or the parcel service provider and applies the registered post by using member information may verify corresponding statistical information and detailed information of an undelivered post through the web page or an e-mail of the user as an example, but the present invention is not particularly limited thereto. The handwritten input ratio information of the post ID calculated for each apparatus for automatically receiving a registered post and misrecognized quantity statistics information are used to periodically evaluate and manage the printing quality of the label attached to the post.

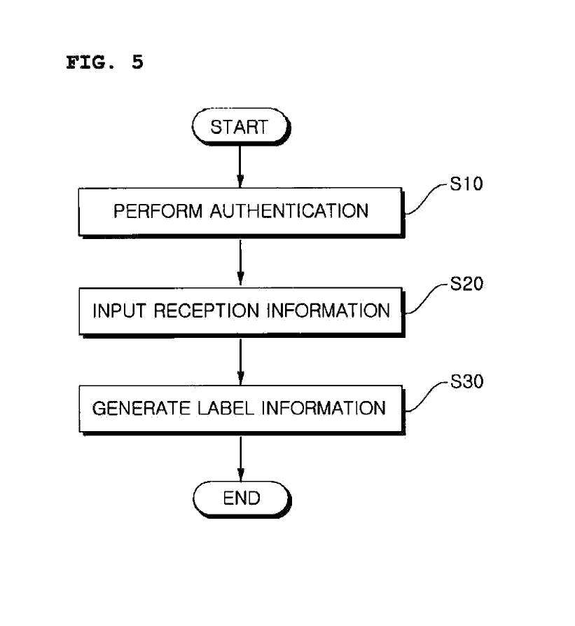

Hereinafter, a method for receiving a registered post through the apparatus for receiving a registered post according to the aforementioned exemplary embodiment will be described with reference to FIG. 5.

FIG. 5 is a flowchart illustrating a method for receiving a registered post according to another exemplary embodiment of the present invention. The method for automatically receiving a registered post according to the exemplary embodiment of the present invention includes a user authenticating step (S10), a reception information inputting step (S20), and a label information generating step (S30).

In the user authenticating step (S10), a user who intends to apply a registered post including a registration or parcel service post is authenticated.

In the reception information inputting step (S20), reception information for receiving the registered post is input.

In the label information generating step (S30), label information for issuing a label including the reception information is generated by verifying the reception information of the registered post.

The reception information inputting step (S20) includes a step of measuring a specification or a weight of the registered post, a step of calculating a postal charge through the measured specification or weight, a step of issuing the label with the generated label information, a step of attaching the issued label to the registered post, and a step of loading a received post or an erroneous post depending on recognition of a barcode of the issued label.

The label information generating step (S30) includes a step of verifying a postal address of the registered post, a step of managing settlement of the calculated charge of the registered post, and a step of generating label information on the registered post of which the charge is settled.

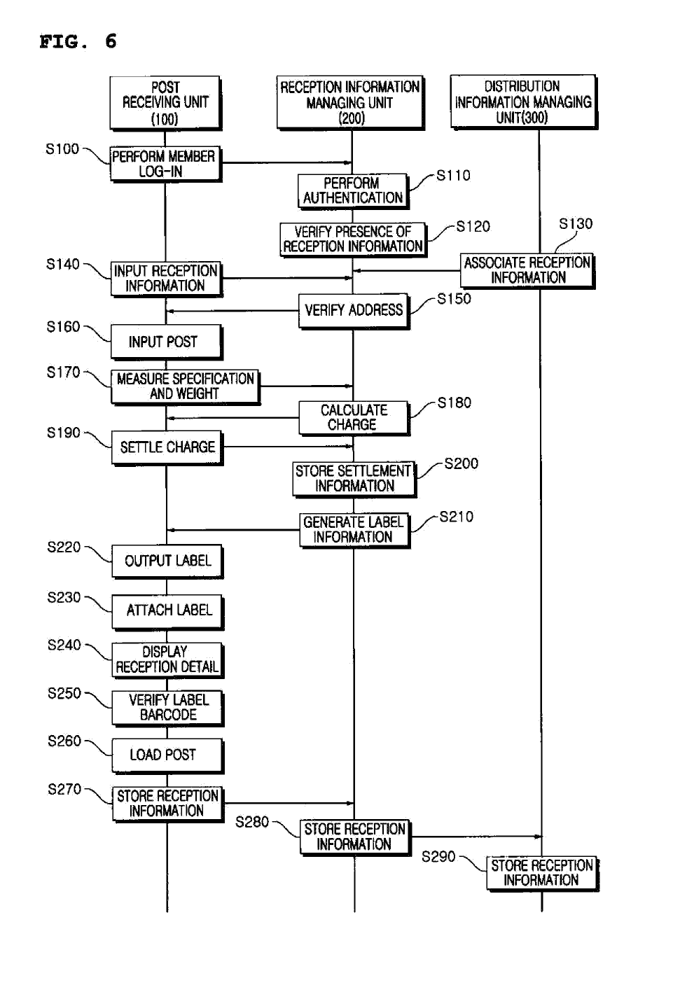

The method for receiving a registered post according to the exemplary embodiment is performed by the apparatus for automatically receiving a registered post according to the aforementioned exemplary embodiment. Therefore, referring to FIG. 6, when a user performs member log-in on a post receiving unit 100 (S100), a member information managing unit 210 of a reception information managing unit 200 performs authentication (S110) and verifies whether reception information previously registered on-line is present based on information stored in the information reception managing unit 220 (S120), and associates the corresponding information when the previously registered reception information is present (S130).

When the user inputs reception information such as a postal address, a recipient name, and the like of a registered post which the user intends to apply (S140), accuracy of a basic address of the postal address is verified in a postal address verifying unit 240 of the reception information managing unit 200 (S150).

When the user inputs a post in which verification of the address accuracy is completed (S160), a specification measuring unit of a post information measuring unit 120 of the post receiving unit 100 recognizes the size of the post and a weight measuring unit measures a weight (S170).

A charge managing unit 250 of the reception information managing unit 200 determines a type of the post based on the measured specification and weight information and calculates a charge depending on specification and weight sections (S180). The user may cancel reception due to changing his/her mind after verifying the calculated charge information and the post is separately discharged and loaded on a post discharging unit 180 when the user cancels the reception.

When the user completes the charge settlement (S190), the corresponding information is stored in the charge managing unit 250 (S200) and information included in a label to be attached in order to provide tracking and tracing information to the input post is generated (S210).

The post receiving unit 100 outputs the label based on information transmitted from a label information generating unit 230 of the reception information managing unit 200 (S220) and automatically attaches the label by verifying a location of the label to be attached to the post (S230).

The user may verify a reception detail through an administration information displaying unit 110 (S240). Whether additional reception is present is verified and thereafter, a receipt is issued. An ID barcode of the post in which the attachment of the label is completed is scanned, and as a result, recognition information is stored in order to verify label barcode printing quality (S250).

According to a result of verifying the label barcode printing quality, the post is loaded on a received post loading unit or an erroneous post loading unit of a loading unit 160 (S260).

The post receiving unit stores a reception detail and label quality verification information as the reception information (S270) and the stored reception information is transmitted to the information reception managing unit 220 of the reception information managing unit 200 and a distribution reception information managing unit 310 of a distribution information managing unit 300 (S280 and S290).

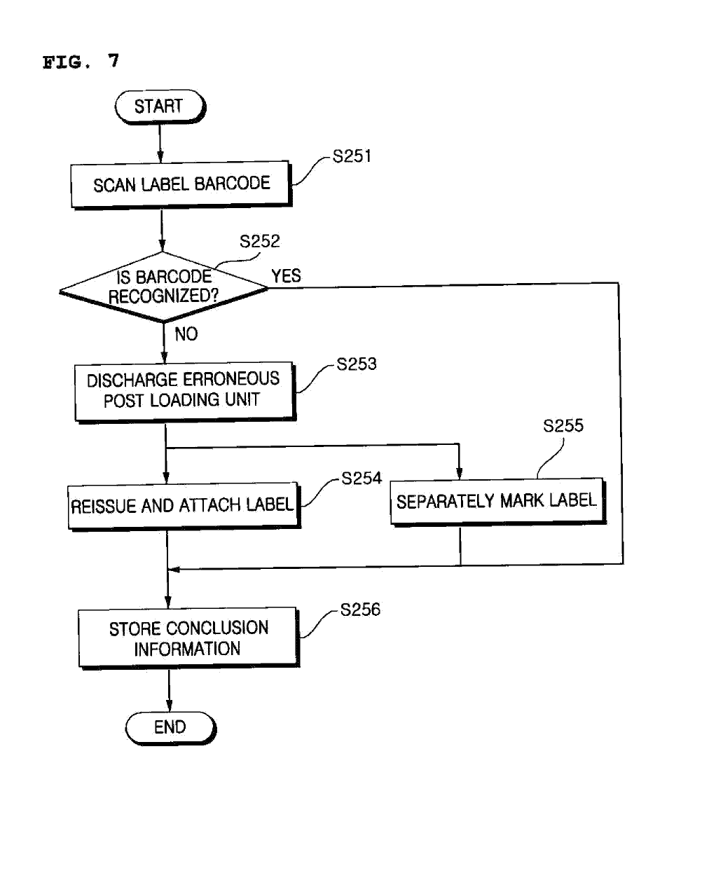

FIG. 7 is a flowchart illustrating a procedure of verifying the quality of a label automatically attached to the registered post according to the exemplary embodiment of the present invention. The label verifying unit 170 scans a barcode included in a label automatically attached to the surface of the post in the label attaching unit 150 by means of a scanner before the post is discharged to the loading unit 160 (S251). Scan information is stored in the post receiving unit 100 and the label verifying unit 170 determines whether barcode is recognized (S252). The post in which the recognition of the barcode is completed is discharged to the received post loading unit of the loading unit 160, and the post which cannot be recognized is discharged to the erroneous post loading unit of the loading unit 160 (S253) to automatically recognize ID information through label reissuing and attachment when a receptionist picks up the post (S254). When the label reissuing is impossible or post ID information printed on the reissued label cannot be automatically recognized, a post ID is input through handwriting and is separately marked on the label (S255) and thereafter, is processed to be recognized in subsequent process steps. Additional businesses may be removed, which may occur in a conclusion business performed to provide registered post tracking and tracing information at post sorting and delivery strongpoints due to a barcode printing failure during reception through such a verification procedure, and cut-off of the tracking and tracing information may be prevented. It is possible to immediately verify a problem in degradation of printing quality of the label barcode which is issued due to an uneven surface of the input post, a failure of a printing device in the post receiving unit, and as a result, system maintenance may be achieved. The information which the receptionist scans or inputs through handwriting at the time of picking up the post loaded on the received post loading unit and the erroneous post loading unit of the loading unit 160 is stored as conclusion information in order to generate reception strongpoint dispatching information in the tracking and tracing information of the registered post (S256).

Meanwhile, the method for receiving a registered post of the present invention may be implemented by a computer-readable code in a computer-readable recording medium. The computer-readable recording medium includes all kinds of recording devices storing data which may be read by a computer system.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for receiving a registered post, comprising:
a post receiving unit receiving reception information for receiving the registered post including a registered or parcel service post; and
a reception information managing unit authenticating a user who intends to apply the registered post and verifying the reception information of the registered post to generate label information for issuing the label including the reception information.

2. The apparatus of claim 1, wherein the post receiving unit includes:
an administration information displaying unit providing a user interface for receiving the registered post;
a post information measuring unit measuring a specification and a weight of the registered post;
a charge calculating unit calculating a postal charge through the measured specification or weight;
a label issuing unit issuing a label with label information generated by the reception information managing unit;
a label attaching unit attaching the issued label to the registered post; and
a loading unit loading a received post or an erroneous post depending on recognition of a barcode of the issued label.

3. The apparatus of claim 1, wherein the reception information managing unit includes:
a member information managing unit managing the user information;
a information reception managing unit storing reception information of a registered post previously applied by the user;
a label information generating unit generating the label information;
a postal address managing unit verifying a postal address of the registered post;
a charge managing unit managing a calculated charge of the registered post; and
a reception managing unit managing the reception information and the label information.

4. The apparatus of claim 1, further comprising:
a distribution information managing unit managing the reception information and delivery information depending on delivery of the registered post.

5. The apparatus of claim 4, wherein the distribution information managing unit includes:
a distribution reception information managing unit managing the reception information received from the post receiving unit and the reception information managing unit;
a sorting information managing unit managing information sorted depending on destination information of the registered post;
a delivery information managing unit managing delivery information of the registered post;
a metabolic information managing unit managing quantity information of the registered post based on a predetermined reference; and
a statistical information managing unit managing statistical information of the registered post.

6. The apparatus of claim 5, wherein the reception information managing unit receives reception information from the user or receives prestored reception information from the distribution information managing unit depending on presence of prestored reception information of the user.

7. The apparatus of claim 2, wherein the post receiving unit further includes a label verifying unit verifying recognition of a barcode of the attached label, and
the label issuing unit reissues a label for an erroneous post in which recognition of the barcode of the label is impossible.

8. The apparatus of claim 2, wherein the loading unit includes:
a received post loading unit loading the received post in which recognition of the barcode of the label is possible; and
an erroneous post loading unit loading the erroneous post in which the recognition of the barcode of the label is impossible.

9. The apparatus of claim 6, wherein the post receiving unit further includes a post discharging unit discharging the registered post when post reception is cancelled or there is no prestored reception information.

10. A method for receiving a registered post, comprising:
authenticating a user who intends to apply the registered post including a registered or parcel service post;
receiving reception information for receiving the registered post; and
generating label information for issuing a label including the reception information by verifying the reception information of the registered post.

11. The method of claim 10, wherein the receiving of the reception information includes:
measuring a specification or a weight of the registered post;
calculating a postal charge through the measured specification or weight;
issuing a label with the generated label information;
attaching the issued label to the registered post; and
loading a received post or an erroneous post depending on recognition of a barcode of the issued label.

12. The method of claim 10, wherein the generating of the label information includes:
verifying a postal address of the registered post;
managing settlement of a calculated charge of the registered post; and
generating label information on the registered post of which the charge is settled.

13. The method of claim 10, further comprising:
managing reception information depending on reception of the registered post and delivery information depending on delivery of the registered post.

14. The method of claim 10, wherein in the receiving of the reception information, reception information is received from the user or prestored reception information is received depending on presence of the prestored reception information of the user.

15. The method of claim 11, wherein the receiving of the reception information further includes verifying recognition of a barcode of the attached label, and
in the issuing of the label, the label for the erroneous post in which recognition of the barcode of the label is impossible is reissued.

16. The method of claim 11, wherein the loading includes:
loading the received post in which recognition of the barcode of the label is possible; and
loading the erroneous post in which the recognition of the barcode of the label is impossible.

17. The method of claim 16, wherein the receiving of the reception information further includes discharging the registered post when post reception is cancelled or there is no prestored reception information.
